(19) United States
(12) Patent Application Publication
(10) Pub. No.: US 2005/0257938 A1
(43) Pub. Date: Nov. 24, 2005

(54) Sprinkler system

(76) Inventor: Stephen John Elsey, Essex (GB)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/121,513

(22) Filed: May 3, 2005

(30) Foreign Application Priority Data
May 6, 2004 (GB) 04 10003.8
Sep. 24, 2004 (GB) 04 20990.4

(51) Int. Cl. A62C 35/00

(52) U.S. Cl. 169/16; 169/13; 169/37

(57) ABSTRACT

A sprinkler system primarily intended for use in a domestic dwelling to cover an exit route from the dwelling has an accumulator feeding the pipes leading to the sprinkler heads. The accumulator is charged with water under pressure by a pump drawing water from a water main or from a check tank itself fed with water from the water main. A sterilising unit may be provided to allow sterilisation of the water in the pipework.

### BACKGROUND TO THE INVENTION

a) Field of the Invention

This invention relates to a sprinkler system and in particular, though not exclusively, to a sprinkler system intended for use in a domestic dwelling to give safety cover to an access route out of the building.

b) Description of the Prior Art

Sprinkler systems are well known and widely used in buildings to which the general public have access. Further, at least in Europe there are proposals for regulations which will require the provision of sprinkler systems in all new buildings, including private dwelling houses, to give safety cover to at least one access route out of the building, to enhance the prospects for personnel escape from the building in the event of a fire.

A conventional sprinkler system utilises sprinkler heads attached to the ceiling of a building at suitable points where a spray of water would be most effective at assisting control of a fire and escape of personnel from the building. A sprinkler system usually provides a spray of water from the sprinkler heads but the throw of the spray depends upon the operating pressure. If the pressure is low, it is known to provide sprinkler heads which generate a mist rather than a spray of water but the term “sprinkler head” is used herein to refer both to a head which produces a spray and a head which produces a mist.

Each sprinkler head incorporates a fusible plug which melts when exposed to sufficient heat for more than a minimum period. When the plug melts, a valve within the head is permitted to open and a spray of water issues from the head. The heads are connected to pipe work carrying water under pressure, and usually are fed either from a reservoir provided in an upper part of the building (such as in a roof space) or are directly fed from a mains water supply. In the latter case the water supply must have sufficient capacity to accommodate the maximum expected flow rate in the event that most—if not all—of the sprinkler heads open to allow the egress of water. Thus, for a typical public building, there must be a water inlet main of a relatively large diameter, merely to ensure there is a sufficiently high flow rate available for all the sprinkler heads in the building.

Though reservoirs provided in an upper part of a building can be used, the flow rate is limited by the head of water above the sprinklers provided by the reservoir. This usually means large diameter pipes must be installed from the reservoir to the sprinklers to obtain a sufficient flow rate, since that water head may be quite small other than with high rise buildings.

There is also a potential problem with a sprinkler system in that it may not operate for many, many years, if ever during the life of the building within which the system is installed. As such, there is no through-flow of water in the pipes, giving rise to the opportunity for bacteria to proliferate within the stagnant water—and it is known that Legionella pneumophila bacteria is a particular problem in view of its toxicity. If then the system is required to operate, persons escaping from the building may be placed at grave risk. In an attempt to prevent the growth of noxious bacteria within the pipes, it is recommended that a sprinkler system should be drained periodically and then refilled with water containing a sterilising agent.

In large commercial premises, periodic (and typically annual) draining and refilling can be monitored and enforced. However, this is not possible in domestic dwellings and small commercial premises. Consequently, there is a high risk of bacteria growing within the pipework of a domestic sprinkler system.

### BRIEF SUMMARY OF THE INVENTION

The invention aims at improving the conventional sprinkler systems especially when intended for use in a low rise building such as a domestic dwelling. Such a building may have only a relatively small diameter incoming pipe for the mains water supply and as such the maximum flow rate achievable is relatively small, for a sprinkler system.

In an enhanced form, the invention also aims at providing a sprinkler system which is adapted to minimise the likelihood of bacterial growth and contamination in the pipework of the system.

In accordance with the above and other objects, one aspect of this invention provides a sprinkler system comprising a pump adapted for connection to a water source, an accumulator, and a pipe connecting the pump to the accumulator for supplying water under pressure to said accumulator. There is at least one sprinkler head including an openable valve, and a pipe connecting the at least one sprinkler head to the accumulator, whereby the accumulator may be charged with water under pressure ready for supply to the at least one sprinkler head upon the valve thereof opening.

With the sprinkler system of this first aspect of the invention, it becomes possible to store in the accumulator a volume of water under a significant pressure, ready for feeding at least one sprinkler head when the valve in that head opens. Consequent upon that, relatively small bore pipe work may be employed for feeding the or each sprinkler head, so facilitating the installation of the sprinkler system in a domestic dwelling.

In an attempt to reduce the likelihood of bacterial infection of the water in the pipes of a sprinkler system, a second aspect of this invention provides a sprinkler system comprising: an incoming water source; a storage tank arranged to receive water from said water source; an accumulator; a pump; and pipes connecting the pump with said storage tank and said accumulator whereby the pump draws water from the storage tank and feeds that water under pressure to the accumulator. The system further comprises at least one sprinkler head having an operable valve; and pipework defining a circuit from the accumulator to the tank, said at least one sprinkler head being connected to said pipework. A circulating valve is disposed in said pipework between the tank and the sprinkler head logically nearest the tank, whereby a sterilising agent can be introduced into said tank whereafter opening the circulating valve and operating the pump causes water carrying said sterilising agent to flow around the circuit to sterilise the sprinkler system.

The sprinkler system as just described obviates the need for periodic draining and refilling of the pipework associated with the system. By having the system cycle periodically, by opening the circulating valve and operating the pump, a circulating flow may be established and if an appropriate dose of a sterilising agent is introduced into that flow, significant growth of bacteria may be prevented.

### BRIEF DESCRIPTION OF THE DRAWINGS

Two embodiments of sprinkler system of this invention are shown in the accompanying drawings, in which:

FIG. 1 diagrammatically illustrates the important components of the first embodiment of sprinkler system, intended for use in a domestic dwelling; and

FIG. 2 similarly illustrates the important components of the second embodiment, intended to reduce the likelihood of bacterial contamination of a sprinkler system.

### DETAILED DESCRIPTION OF THE INVENTION

In the domestic form of this invention, the accumulator is charged with water at a raised pressure with respect to the incoming mains pressure by the action of the pump. Preferably, the pressure is maintained in the accumulator by the provision of a check valve upstream of the accumulator, and advantageously a double check valve having two check valves in series is provided between the pump and the accumulator.

For most applications, the pump should be driven by an electric motor, conveniently powered by the electricity mains supply. A pressure-sensitive switch may be arranged to sense the static pressure of the water delivered by the pump to the accumulator, which switch then serves to control the supply of electric power to the pump. In this way, the consumption of energy may be minimised while still ensuring that there is always sufficient pressure in the accumulator for the charge of water therein.

In a case where a pressure-sensitive switch is provided, instead of directly controlling the supply of electricity to the pump motor, the switch may be connected to a control unit such that when the switch is triggered by falling water pressure, the control unit initiates various actions responsive to that pressure drop. Once the system has been installed and pressurised, unless there is a leak or other failure the only reason that the pressure in the accumulator should fall is if a sprinkler head opens, the outflow of water therefrom causing the pressure of the stored water to fall. Thus, on sensing that fall in pressure, the control unit may immediately turn on the pump and also initiate the sounding of a fire alarm, such as a bell, hooter or siren. Further, the control unit may signal to a centralised call centre that there is a problem requiring immediate attention, in the building fitted with the system.

The control unit may also perform various tests on the system at periodic intervals. For example, the control unit may turn on the pump once a month, in order to ensure that the pump is capable of operating normally when required. By monitoring for pump operation, for example by a small increase in pumped pressure when the pump is operated, a warning may be given if it is apparent there is no such increase and consequently that there is a fault with the pump or its motor.

In order to ensure reliability of the system, it would be possible to provide two pumps in parallel, each driven by a respective electric motor. This may reduce potential problems over corrosion and sticking of a pump which always has water therein, but which is required to operate only very infrequently.

The inlet to the pump may be directly connected to an incoming mains water supply. In this case the maximum rate of charging of the accumulator will be limited to the maximum flow rate along the mains water supply pipe but mostly it is envisaged that the pump will have a relatively low flow rate, though able to generate a relatively high pressure. As an alternative, the pump may draw water from a break tank fed with water from an incoming mains supply pipe, which tank is provided with a float valve assembly to maintain a preset level of water in that tank.

This invention extends to a sprinkler system of this invention as described above in combination with a building having access routes leading to external doors, wherein the access routes out of the building are provided with sprinkler heads connected to said pipe of the sprinkler system.

Turning now to the enhanced form of this invention, it will be appreciated that though it would be possible to manually introduce the sterilising agent to the tank whenever a sterilising cycle is to be performed, it is highly preferred that mechanical means are provided to control the introduction of the sterilising agent. Thus, advantageously there is provided a power-operated dosing mechanism arranged to introduce a measured quantity of a sterilising agent into the tank, whenever a sterilising cycle is to be performed. A control arrangement may be provided to control the operation of the dosing mechanism at preset regular intervals. In this case, by providing a power-operated circulating valve the control arrangement may also control the operation of that valve, as well as the operation of the pump.

The control arrangement may be arranged to perform a sterilising cycle at appropriate intervals, having regard to the installation, the number of sprinkler heads, the mean ambient temperature, and so on. Typically, operation once a year may be sufficient though in some circumstances more frequent operation may be desirable, such as quarterly or even monthly. More frequent operation also reduces the likelihood of component failure, such as seizure of a pump or valve.

The sterilising agent advantageously is in liquid form, so as to prevent a build-up of undissolved agent. The agent may comprise a chlorine based liquid or a quaternary ammonia compound, or any other suitable liquid bactericide. Preferably, the agent is added once the circulating flow has been established in order to assist the distribution of the agent throughout the water in the system.

The enhanced system of this invention, though primarily intended for small-scale installations such as for a low rise domestic dwelling, may be expanded to relatively large-scale sprinkler systems. In such a case, it may be necessary to zone the system and have flow through each zone in turn, in order to ensure an adequate circulating flow throughout all of the pipes of the system. The circulating valve preferably is disposed in the pipework immediately adjacent the tank, but could be provided anywhere between the tank and the sprinkler logically nearest (with respect to the pipework, and not necessarily physically nearest) the tank.

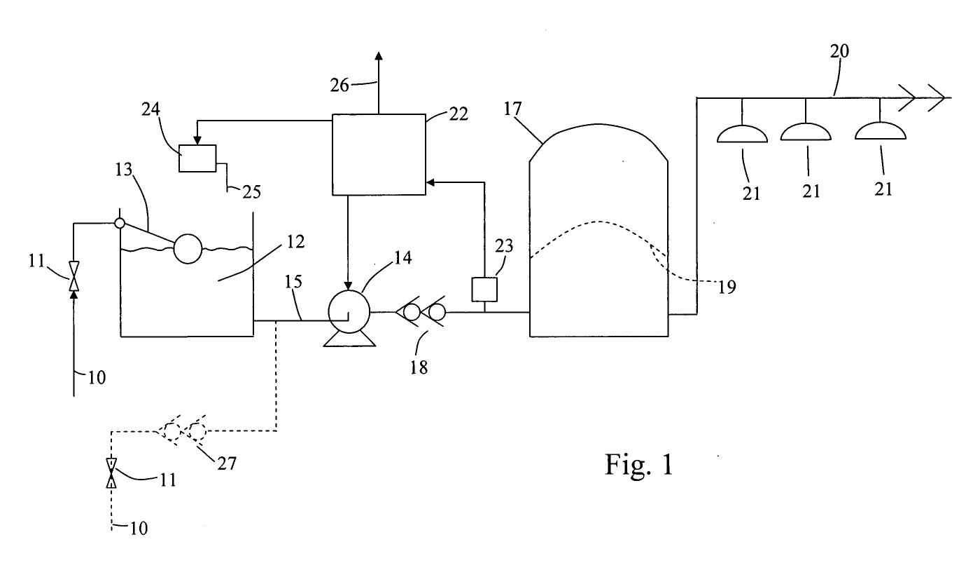

Reference will now be made to FIG. 1, showing a simple form of domestic sprinkler system intended to give safety cover for an egress route from a building. An incoming mains water pipe 10, such as a cold water riser in a domestic dwelling, is fitted with a stopcock 11 arranged to feed water to a break tank 12 fitted with a float valve assembly 13 to maintain a preset water level in the tank. A pump 14 driven by an electric motor draws water from the tank 12 through a pipe 15, the outlet of the pump being supplied through pipe 16 to an accumulator 17. A double check valve 18 is provided in pipe 16, to prevent back-flow of water from the accumulator 17 through the pump 14 and into the tank 12.

The accumulator 17 is essentially conventional and comprises a generally cylindrical pressure vessel within which is provided a resiliently deformable diaphragm 19, the space above the diaphragm being closed and pre-charged with air under pressure. On supplying water under pressure through pipe 16 to the space below the diaphragm 19, the resilient diaphragm 19 compresses air in the space above the diaphragm whereby the water is stored in the accumulator under a significant pressure.

An outlet pipe 20 from the accumulator 17 connects to a plurality of sprinkler heads 21, though the number of heads should be selected for the particular installation. Typically, each sprinkler head includes a fusible plug which melts when the head is subjected to more than a preset temperature, for more than a preset period. On melting, the plug allows a water control valve in the head to open, thereby allowing water to flow out of the head, in a spray pattern. Such sprinkler heads are well known in the art and will not be described in further detail here as the head construction forms no part of this invention.

The accumulator 17 should have a sufficient capacity to allow the supply of water to all of the sprinkler heads 21 connected to the outlet pipe 20, for some predetermined period of time, dependent upon the kind and arrangement of the building within which the sprinkler system is installed. Typically, therefore, it is envisaged that an accumulator for a sprinkler system intended for use in a domestic dwelling and being provided with three or four sprinkler heads may have a capacity of 400 to 800 litres and should be arranged to operate at a pressure of about 3 bar. To achieve this, the pump should be able to pump water at the rate of 1 to 10 litres per minute, at 1 bar pressure, the throughput of the pump falling as the pumped pressure increases.

The electric motor driving the pump 14 in a domestic application would be powered by the domestic mains supply—in Europe, a 230 volt single phase 50 Hz mains supply. The pump 14 may have a relatively small capacity in terms of its maximum volume throughput, but should be capable of pumping to relatively high pressures in order to ensure that a sufficiently large charge of water under high pressure might be stored within the accumulator 17. Since the charging of the accumulator may be performed over an extended period when the sprinkler system is not required for active use, the flow rate of the pump at maximum pressure is not of concern.

A control unit 22 is provided for controlling operation of the electric motor driving the pump 14. A pressure-sensitive switch 23 is provided in pipe 16 from pump 14 and supplies an output to the control unit 22, for controlling the supply of the electricity to the electric motor driving the pump. A further possibility would be to furnish such a pressure-sensitive switch directly to sense the pressure within the accumulator, or at the outlet from the pump 14. When a sufficient pressure has been achieved, the switch 23 may open (or close, as appropriate) the operation of the switch being sensed by the control unit 22 so as to cut off the supply of electricity to the pump and conserve energy. If however the pressure in the system falls for any reason, such as the presence of a minor leak, the pump will be driven again in order to maintain the optimum pressure in the accumulator.

The system may also include a chemical dosing unit 24 having an outlet pipe 25 arranged to feed a sterilising agent into the tank 12. The dosing unit is controlled by the control unit 22, whereby chemical may be dropped into the tank 12 at periodic but infrequent intervals.

The control unit 22 may include an alarm output 26, arranged to trigger an alarm if certain error conditions are detected. For example, by monitoring the current supply to the electric motor driving the pump 14, it would be possible to determine whether the pump has seized and so is not operating when the motor has been energised. Equally, if there is a minor leak leading to frequent operation of switch 23, this may be determined by the control unit 22 so as to energise the alarm output 26.

Though the system described above utilises a break tank 12, for systems where there is a sufficient inflow of water from the mains supply, that tank may be eliminated and the inlet to the pump may be connected directly to the incoming mains supply, as shown in phantom lines in FIG. 1. In this case, a double-check valve 27 should be provided between the stopcock 11 and the motor inlet pipe 15.

The control unit 22 may be modified so as to cause operation of the motor driving the pump 14 only once the pressure has risen to slightly less than the pressure of the incoming mains water supply. Thus, the mains water pressure is used to perform the initial charge of the accumulator up to slightly less than the pressure of the incoming supply and then the pump is operated in order to boost the pressure within the accumulator, to the required operating pressure of about 3 bar.

With the above-described sprinkler system, it becomes possible to furnish a small domestic dwelling with an effective and reliable sprinkler system despite the dwelling having only a relatively small diameter incoming mains water supply pipe, or in areas where there is only a relatively low pressure mains supply.

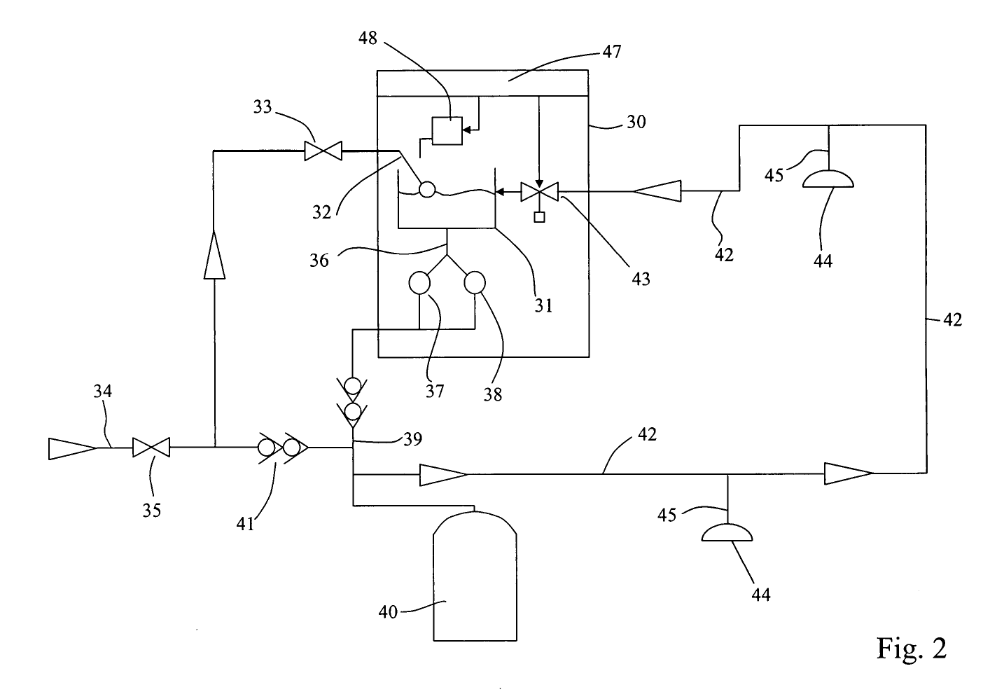

FIG. 2 shows an enhanced form of the sprinkler system of FIG. 1, intended to reduce the likelihood of bacterial contamination of the water in the system. In the system of FIG. 2, there is provided a dosing arrangement for sterilising water within the pipework of the system. The system includes a housing 30 within which is provided a priming and dosing tank 31 having a ball valve assembly 32 connected through a stopcock 33 to an incoming mains water supply pipe 34, also provided with a stopcock 35. The ball valve assembly 32 serves to maintain at a preset level the water in the tank 31. An outlet pipe 36 from the tank 31 connects to two similar electric circulating pumps 37,38 arranged in parallel and feeding an accumulator pipe 39, leading to an accumulator 40. As shown, a double-check valve may be provided in accumulator pipe 39 to prevent backflow through the pumps, if those pumps do not themselves have back-flow check valves. The downstream side of the stopcock 35 in the supply pipe 34 also connects directly to the accumulator pipe 39, but through a double non-return valve 41, to ensure there can be no backflow of water from the sprinkler system to the incoming mains water supply pipe 34.

Pipework 42 provides a circuit for water, from the accumulator pipe 39 back to the tank 31, through an electrically-operated circulating valve 43 disposed within the housing 30, adjacent the tank 31. Sprinkler heads 44 are connected to that pipework 42 as required, but it is important that the feed pipes 45 which connect each sprinkler head 44 to the pipework 42 are as short as possible, to minimise the volume of water between the pipework 42 and each sprinkler head 24. Ideally, the pipework 42 is arranged so that each sprinkler head may be connected essentially directly to that pipework, without the need to provide a separate elongate feed pipe 45.

In the upper part of the housing 30, there is provided a control unit 47 and a dosing mechanism 48. The control unit 47 controls and monitors operation of the overall system and has outputs for powering the pumps 37 and 38, for the dosing mechanism 48 and for the circulating valve 43. The dosing mechanism 48 typically has a reservoir for concentrated sterilising liquid, such as a quaternary ammonium compound, together with an electrically-operated single-shot pump arranged so that on operation of the pump by the control unit 47, a measured quantity of the sterilising liquid is drawn from the reservoir and is discharged into the tank 31. The control unit 47 provides the required electrical power to the single-shot pump to discharge the agent and then reset the pump ready for another discharge cycle. The control unit 47 has a microprocessor to control the various functions to be performed, these including the initiation of a sterilising cycle at preset intervals, as well as the duration of the sterilising cycle. Further, the control unit may selectively operate pump 37 or pump 38, or operate both pumps together.

The control unit 47 may include an alarm which is triggered whenever a fault condition is detected. For this purpose, various sensors may be provided for the proper operation of the system which sensors are connected back to the control unit so as to provide the required inputs for monitoring proper operation. Typically, alarm conditions may be flagged if it is detected that: either one of the two pumps does not operate when power is supplied thereto; the circulating valve does not open and close as required; the water level in the tank 31 falls below a predetermined level; the pressure in the pipework 42 falls below a predetermined value; the sterilising agent in the reservoir of the dosing mechanism 48 falls below a predetermined quantity; and there is no discharge of agent on operation of the single-shot pump of the dosing mechanism 48.

Further, a sensor could be provided for the concentration of the sterilising agent in the water within the pipework 42 and in the event that concentration falls below a predetermined level, a sterilising cycle could be initiated. If that cycle fails to restore the concentration level to above the specified level, an alarm condition could be flagged.

The volume of the accumulator 39 should be selected such that there will be an adequate outflow of water through the sprinkler heads 44 in the event that those heads open when there is a fire. Thus, the volume of the accumulator should be selected having regard to the volume of the pipework 42, the number of sprinkler heads, the volume of the tank 31 and also the pressure of the incoming mains water supply. In this connection, it will be appreciated that when the sprinkler heads have opened and there is an outflow of water therefrom, the pressure in the pipework 42 will fall and the water in the accumulator will discharge. When the pressure in the pipework 42 falls to below the pressure of the incoming mains in supply pipe 34, there will be flow through the double non-return valve 41 from that supply pipe 34, into the pipework 42 so that there will be a continuing feed of water to the sprinkler heads 24.

As with the first embodiment, the use of an accumulator as described and with a sufficient capacity facilitates the implementation of the sprinkler system within a domestic dwelling though the system may be used in other premises such as small commercial enterprises, shops and so on.

1. A sprinkler system comprising a pump adapted for connection to a water source, an accumulator, a pipe connecting the pump to the accumulator for supplying water under pressure to said accumulator, at least one sprinkler head including an openable valve, and a pipe connecting the at least one sprinkler head to the accumulator, whereby the accumulator may be charged with water under pressure ready for supply to the at least one sprinkler head upon the valve thereof opening.

2. A sprinkler system as claimed in claim 1, wherein there is provided a check valve between the pump and the accumulator.

3. A sprinkler system as claimed in claim 2, wherein said check valve comprises a double-check valve having two independent check valves arranged in series.

4. A sprinkler system as claimed in claim 1, wherein an electric motor is arranged to drive said pump.

5. A sprinkler system as claimed in claim 4, wherein there is provided a pressure-sensitive switch for said electric motor driving the pump, said switch being arranged to sense the pressure of the water delivered to the accumulator, and to shut-down the pump when the pressure in the accumulator reaches a preset minimum value.

6. A sprinkler system as claimed in claim 1, wherein the pump is directly connected to an in-coming mains water supply.

7. A sprinkler system as claimed in claim 1, and further comprising a water tank supplied with water from an in-coming mains water supply, the pump being connected to the tank to draw water therefrom.

8. A sprinkler system as claimed in claim 7, wherein the tank is fitted with a float-valve assembly to maintain the water level in the tank at a preset level.

9. A water supply system as claimed in claim 1, wherein there is provided a sterilising unit arranged to introduce a measured quantity of a sterilising agent into the water pumped to the accumulator.

10. A sprinkler system as claimed in claim 1, wherein a plurality of sprinkler heads is connected to said pipe, for the supply of water thereto.

11. A sprinkler system comprising:
an incoming water source;
a storage tank arranged to receive water from said water source;
an accumulator;
a pump;
pipes connecting the pump with said storage tank and said accumulator whereby the pump draws water from the storage tank and feeds that water under pressure to the accumulator;
a pump;
at least one sprinkler head having an operable valve;
pipework defining a circuit from the accumulator to the tank, said at least one sprinkler head being connected to said pipework; and
a circulating valve disposed in said pipework between the tank and the sprinkler head logically nearest the tank;
whereby a sterilising agent can be introduced into said tank whereafter opening the circulating valve and operating the pump causes water carrying said sterilising agent to flow around the circuit to sterilise the sprinkler system.

12. A sprinkler system as claimed in claim 11, wherein mechanical means are provided to control the introduction of the sterilising agent into the tank.

13. A sprinkler system as claimed in claim 12, wherein there is provided a power-operated dosing mechanism arranged to introduce a measured quantity of a sterilising agent into the tank.

14. A sprinkler system as claimed in claim 13, wherein a control arrangement is provided to control the operation of the power-operated dosing mechanism at preset regular intervals.

15. A sprinkler system as claimed in claim 11, wherein the circulating valve is power-operated and is arranged to be opened whenever the pump is operated.

16. A sprinkler system as claimed in claim 14, wherein the circulating valve is power-operated and the control arrangement controls operation of the dosing mechanism, the power-operated circulating valve and the operation of the pump.

17. A sprinkler system as claimed in claim 16, wherein the control arrangement is arranged to initiate a sterilising cycle at preset intervals, the sterilising cycle comprising triggering of the dosing mechanism to supply a dose of sterilising agent, opening of the circulating valve and operating of the pump for a preset period so as to have a circulating water flow through the pipework for that period.

18. A sprinkler system as claimed in claim 17, wherein the circulating water flow is established before the dosing mechanism is triggered.

19. A sprinkler system as claimed in claim 11, wherein a second pump is provided in parallel with said pump, the said pump and the second pump being pumps operable one of simultaneously and separately.

20. A sprinkler system as claimed in claim 19 and in which there is provided a control arrangement for the dosing and mechanism, circulating valve, said control arrangement controlling the selection of the which pump is to operate.

21. A sprinkler system as claimed in claim 6, wherein the control arrangement includes an alarm adapted to be triggered if a fault condition is detected.

22. A sprinkler system as claimed in claim 21, wherein a detected fault condition includes any one of non-circulating water flow during pump operation, non-operation of the dosing mechanism when triggered, and low water level in the tank.

23. A sprinkler system as claimed in claim 11, wherein the tank, pump and valve are contained in an enclosure.

24. A sprinkler system as claimed in claim 11, wherein an automatically-operating mechanism is provided to maintain the water level in the tank at a pre-determined value, by replenishing water from the incoming water source.

25. A sprinkler system as claimed in claim 11, wherein water from the incoming water source is directly connected to said pipework, through a non-return valve.

26. The combination of a building and a sprinkler system as claimed in claim 1, wherein an access route out of the building is provided with at least one sprinkler head connected to said pipe.

27. The combination of a building and a sprinkler system as claimed in claim 11, wherein an access route out of the building is provided with at least one sprinkler head connected to said pipe.
